(19) United States
(12) Patent Application Publication
(10) Pub. No.: US 2015/0269051 A1
(43) Pub. Date: Sep. 24, 2015

(54) DEVICE AND METHOD FOR EVALUATING SYSTEM PERFORMANCE

(71) Applicants: Samsung Electronics Co., Ltd., Suwon-si, Gyeonggi-do (KR); RESEARCH & BUSINESS FOUNDATION SUNGKYUNKWAN UNIVERSITY, Suwon-si, Gyeonggi-do (KR)

(72) Inventors: Ji-Hoon Park, Seoul (KR); Seung-Hyun Yoon, Suwon-si (KR); Seung-Wook Lee, Seoul (KR); Jae-Wook Jeon, Suwon-si (KR); Seong-Jin Cho, Suwon-si (KR)

(21) Appl. No.: 14/418,696

(22) PCT Filed: Jul. 31, 2013
(86) PCT No.: PCT/KR2013/006910

§ 371 Date: Jan. 30, 2015

(30) Foreign Application Priority Data
Jul. 31, 2012 (KR) 10-2012-0083763

(51) Int. Cl. G06F 11/34; G06Q 10/06

(52) U.S. Cl. CPC G06F 11/3409; G06Q 10/0639

(57) ABSTRACT

A device and a method for evaluating the performance of a system on the basis of a user experience are disclosed. To this end, experience information of a user according to the driving of an embedded system is collected on the basis of a predetermined or preset condition, and a scenario selection condition is set in order to select a scenario for evaluating the performance of the embedded system. An experience pattern of the user is analyzed by requisite experience information obtained from the collected experience information on the basis of the set scenario selection condition, and an optimal scenario for evaluating the performance of the embedded system is selected among a plurality of available scenarios on the basis of the results according to the analysis, thereby evaluating the performance of the embedded system using the selected scenario.

### TECHNICAL FIELD

The present disclosure relates to apparatuses and methods for evaluating performance of a system, and more particularly, to an apparatus and method for evaluating performance of a system based on user experiences.

### BACKGROUND ART

Recently, complex embedded devices, such as portable devices, including Central Processing Units (CPUs), Graphic Processing Units (GPUs), or the like are on the market. The performance of the embedded device depends on types, structures, etc., of the internal chips. In this respect, objective evaluation of the performance of the embedded device is commonly conducted by running a particular program and measuring the running time of the program or the like.

For example, the performance of a system may be evaluated through simulation of software operations over time or by measuring the time required by running multiple programs.

Thus, conventional technologies for evaluating the performance of a system do not take into account user experiences. Evaluating performance of a system with a target program, which is not frequently used in the system, may result in differences between measured performance and actual performance the user feels.

Furthermore, the conventional technology for evaluating the performance of a system focuses on evaluating performance of a CPU equipped in the system, and thus it is not easy to evaluate the system's performance if a GPU or a hardware platform (HW IP) is mixedly used in the system.

Accordingly, an urgent need exists for a method for evaluating complex performance of main components of a system subject to the performance evaluation.

### DISCLOSURE

### Technical Problem

The present disclosure provides an apparatus and method for evaluating objective performance of a system by running a scenario based program that uses a user experience.

The present disclosure also provides an apparatus and method for evaluating actual performance of a system by configuring an evaluation program based on a scenario that is frequently used by the user for performance evaluation on a system.

The present disclosure also provides an apparatus and method for evaluating performance of mixed configurations in a system by running a scenario based program that uses a user experience.

### Technical Solution

In accordance with an aspect of the present disclosure, a method for evaluating performance of an embedded system in a performance evaluation apparatus is provided. The method includes obtaining requisite experience information from a database built in advance based on user experience information in using the embedded system, under a predetermined condition for scenario selection; determining a performance evaluation scenario in consideration of the obtained requisite experience information; and evaluating performance of the embedded system according to the determined performance evaluation scenario.

In accordance with another aspect of the present disclosure, a performance evaluation apparatus for evaluating performance of an embedded system is provided. The performance evaluation apparatus includes a scenario selector for obtaining requisite experience information from a database built in advance based on user experience information in using the embedded system, under a predetermined condition for scenario selection, and determining a performance evaluation scenario in consideration of the obtained requisite experience information; and a performance evaluator for evaluating performance of the embedded system according to the determined performance evaluation scenario.

### DESCRIPTION OF DRAWINGS

FIG. 1 shows an arrangement of an entire system for performance evaluation, according to an embodiment of the present disclosure;

FIG. 2 is an arrangement of a performance evaluation apparatus 110 for evaluating performance of a system based on a user experience, according to an embodiment of the present disclosure;

FIG. 3 is a detailed arrangement of a scenario selector 230 shown in FIG. 2;

FIG. 4 is a detailed arrangement of a performance evaluator 240 shown in FIG. 2;

FIG. 5 is a control flowchart for performing performance evaluation on an embedded system by a performance evaluation apparatus 110, according to an embodiment of the present disclosure; and

FIG. 6 is a control flowchart corresponding to detailed operations according to a performance evaluation subroutine of FIG. 5.

### BEST MODE

In the following description, representative embodiments of the present disclosure will be explained. For convenience of explanation of the present disclosure, well-known technical terms may be used as intact. However, the terms are not limited thereto, and are, of course, modified to be equally applied to a system with a similar technical background.

In the following embodiment of the present disclosure, configurations and operations of collecting information regarding a user experience (hereinafter, referred to as ‘experience information’) to be taken into account to select a scenario for evaluation of system performance, selecting a scenario to be applied for evaluation of system performance, and performing performance evaluation based on the selected scenario will be described.

Embodiments of the present disclosure will be described in detail with reference to accompanying drawings. It is noted that like numerals refer to like elements throughout the drawings. Detailed description of well-known functionalities and configurations will be omitted to avoid unnecessarily obscuring the present invention

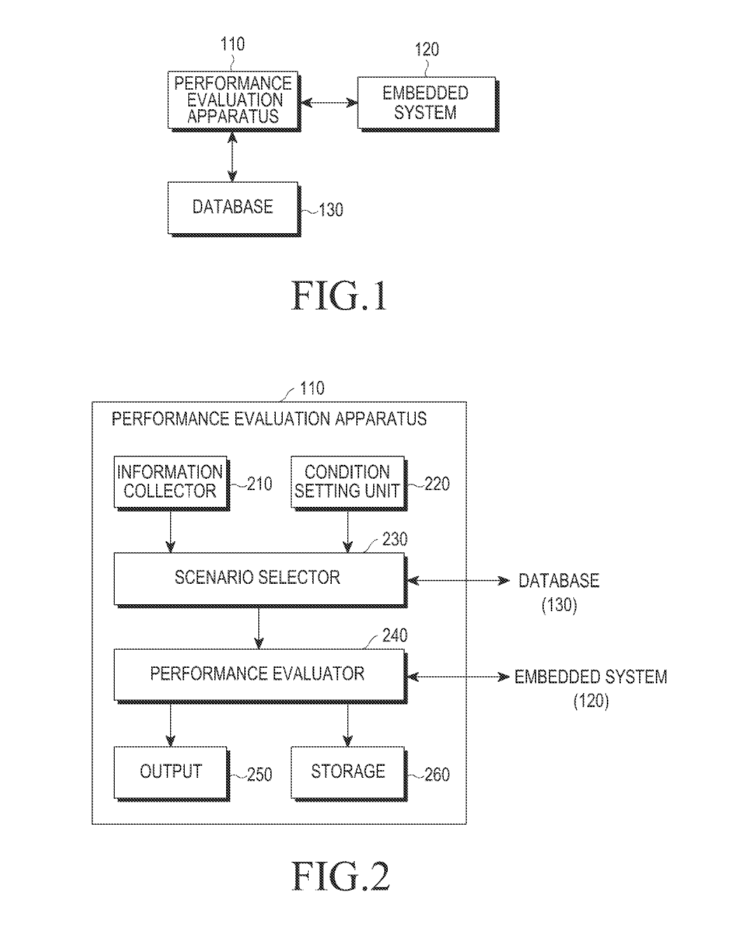

FIG. 1 shows an arrangement of an entire system for performance evaluation, according to an embodiment of the present disclosure. The entire system may include a performance evaluation apparatus 110, an embedded system 120, and a database 130. The performance evaluation apparatus 110 and the database 130 may be incorporated into the embedded system 120. Otherwise, at least one of the performance evaluation apparatus 110 and the database 130 may be incorporated into the embedded sytem 120.

Referring to FIG. 1, the performance evaluation apparatus 110 may collect the user experience information and provide the experience information to the database 130. The user experience information as used herein may refer to information regarding the user experience to be used to evaluate performance of the embedded system 120 subject to performance evaluation. For example, the experience information may include information about the user's age, gender, location, weather, etc., and information about a type, the number of running (running frequency), a running time, etc., of a program the user has used.

The performance evaluation apparatus 110 may set a condition for selection of a scenario, and select a best-case scenario for performance evaluation on the embedded system 120 by taking into account the experience information that has been collected in advance under the set condition for scenario selection.

For example, the performance evaluation apparatus 110 may obtain requisite experience information from the collected experience information and analyze the pattern of the user experience with the requisite experience information.

The condition for scenario selection is information for sort out experience information to be used to select a best-case scenario for performance evaluation on the embedded system 120 from among pieces of experience information stored in the database 130. In other words, the conditions for scenario selection is information for extracting experience information necessary to select the best-case scenario from among pieces of experience information stored in the database 130.

For example, the condition for scenario selection may be the user's age, gender, location, weather, etc., that constitute the experience information. In addition, the conditions for scenario selection may further include information about conditions arranged or set in advance to collect the experience information, i.e., information about programs, users, running times, etc.

The performance evaluation apparatus 110 may select a best-case scenario for performance evaluation on the embedded system 120 from among a plurality of available scenarios based on the result of analysis.

The performance evaluation apparatus 110 may arrange and configure a program to run according to the selected best-case scenario, and allow operations that correspond to the configured program to be performed by the embedded system 120.

The performance evaluation apparatus 110 may analyze the results of performance evaluation conducted on the embedded system 120 with the operations of the program. The performance evaluation apparatus 110 may store or provide the analyzed result to an operator when the analysis on the performance evaluation results is done.

The database 130 may store the user experience information provided from the performance evaluation apparatus 110. The database 130 may extract requisite experience information that meets the condition for scenario selection provided by the performance evaluation apparatus 110, among the stored pieces of experience information, and provide the extracted requisite experience information to the performance evaluation apparatus 110.

Otherwise, the performance evaluation apparatus 110 may just read the requisite experience information from the database 130. In addition, the database 130 may provide all the stored pieces of experience information to the performance evaluation apparatus 110 at the request of the performance evaluation apparatus 110, and enable the performance evaluation apparatus 110 to extract and use the requisite experience information that meets the condition for scenario selection.

As also previously defined, in case the performance evaluation apparatus 110 is contained in the embedded system 120, operations performed by the performance evaluation apparatus 110 may, of course, be performed by the embedded system 120.

FIG. 2 is a detailed arrangement of the performance evaluation apparatus 110 for evaluating performance of a system based on a user experience, according to an embodiment of the present disclosure. The performance evaluation apparatus 110 may include an information collector 210, a condition setting unit 220, a scenario selector 230, a performance evaluator 240, an output 250, and a storage 260.

Referring to FIG. 2, the information collector 210 may collect experience information generated or predicted or measured by the user using the embedded system 120 subject to performance evaluation (hereinafter, generally termed as ‘target system’). For example, the information collector 210 may use a sensor, which may be equipped in the target system or may exist separately from the target system, to collect experience information in driving the target system. The experience information may include the user's age, gender, location, weather, etc.

The information collector 210 may collect the experience information based on a predetermined condition arranged or set in advance. For example, the predetermined condition may be a program, a user, a running time, etc. In other words, the information collector 210 may collect the experience information by programs available for the target system, users, running times, etc.

The experience information collected by the information collector 210 may be provided to the scenario selector 230 to select the best-case scenario for performance evaluation on the target system.

The condition setting unit 220 may set information used in selecting a scenario for performance evaluation, i.e., set a condition for scenario selection. The condition for scenario selection may be information for sorting out the requisite experience information from the pieces of experience information collected in advance. The requisite experience information refers to experience information to be used to select a best-case scenario for performance evaluation on the target system.

For example, as the conditions for scenario selection, the user's age, gender, location, weather, etc., that constitute the experience information may be used. In addition, the condition for scenario selection may further include information about a condition arranged or set in advance to collect experience information, i.e., information about a program, a user, a running time, etc.

The condition setting unit 220 may collect a condition for scenario selection from an operator who conducts performance evaluation on the target system, or set conditions for scenario selection for each scenario in advance and then select one of the conditions. An easiest way to select one of the conditions for scenario selection set in advance is to leave the selection to the operator.

The condition setting unit 220 may provide the set condition for scenario selection for the scenario selector 230 to select a best-case scenario for performance evaluation on the target system.

The scenario selector 230 may send the experience information collected by the information collector 21 to the database 130 contained internally or externally. The database 130 may then store the experience information provided by the scenario selector 210 and mange them with a certain process.

For example, the database 130 may store or manage the experience information collected by the information collector 210 and provided by the scenario selector 230, for each program, each user, or each running time. However, when considering e.g., storage capacity, it is preferable to locate the database 130 externally, i.e., in a remote place accessible over a network. In the case the database 130 is located in a remote place, experience information may be collected for various embedded systems. In this case, the experience information collected by the database 130 may be comprehensive and useful information.

The scenario selector 230 may obtain the requisite experience information from the pieces of experience information collected by the information collector 210 or stored in the database 130, using the condition for scenario selection provided by the condition setting unit 220. For example, the scenario selector 230 may analyze the experience information provided by the information collector 210 or stored in the database 130 based on the condition for scenario selection, and obtain the requisite experience information according to the analyzed result.

However, if the requisite experience information may be provided by the information collector 210 and/or the database 130, the scenario selector 230 does not have to be given the condition for scenario selection from the condition setting unit 220. That is, the operation of the scenario selector 230 obtaining the requisite experience information based on the condition for scenario selection may be omitted.

The scenario selector 230 may select a desired scenario for performance evaluation on the target system, using the obtained requisite experience information. The scenario selector 230 may further take into account a hardware configuration of the target system in addition to the requisite experience information in selecting the scenario.

For example, assume that age (e.g., teens) and gender (e.g., male) are set as the condition for scenario selection to evaluate performance of a program used by many teenage boys. In this case, the scenario selector 230 may access the database 130 that manages the user experience information and obtain the requisite experience information that meets the condition for scenario selection provided by the condition setting unit 220. Specifically, the scenario selector 230 may access the database 130 and obtains the requisite experience information consistent with the current device's information, the teenage as the age, and the male as the gender.

The scenario selector 230 may select a best-case scenario for evaluating performance in driving the program mainly used by teenage boys in the current device, based on the requisite experience information obtained under the condition for scenario selection.

The scenario selected by the scenario selector 230 may be provided to the performance evaluator 240.

The performance evaluator 240 may evaluate performance of the target system according to the scenario selected by the scenario selector 230. For this, the performance evaluator 240 may configure an evaluation program to run on the target system according to the selected scenario, and enable the target system, i.e., the embedded system 120 to be driven by the configured evaluation program.

For example, if a scenario where the user listens to music for about 5 minutes while surfing the web to find information is selected, the performance evaluator 240 may configure a program that corresponds to a web browser and a program to play about 5-minute-long music into the evaluation program.

The evaluation program as configured above may be run by the embedded system 120. The performance evaluator 240 may analyze performance of the web browser and performance of the music reproduction carried out by the embedded system 120. For example, the performance of the web browser and music reproduction may be represented by performance analysis on the respective CPU, GPU, and HW IP. In other words, the performance of the program running on the target system may be represented by performance analysis on the respective CPU, GPU, and HW IP.

In another example, the performance evaluator 240 may provide the evaluation program to the embedded system 120, which in turn runs the evaluation program and provide the results of performance evaluation to the performance evaluator 240. In this case, the performance evaluator 240 may analyze the performance results for the respective CPU, GPU, and HW IP, based on the results of performance evaluation provided by the embedded system 120.

The performance evaluator 240 may provide the results of performance evaluation conducted on the embedded system to the output 250 and/or the storage 260.

The output 250 may provide the results of performance evaluation provided by the performance evaluator 240 to the operator through a medium, e.g., a display. The storage 260 may store the results of performance evaluation provided by the performance evaluator 240 with information about the target system and about weather and date under/on which the performance evaluation was conducted.

If the performance evaluation apparatus 110 is contained in the embedded system 120, the detailed arrangement of the performance evaluation apparatus 110 shown in FIG. 2 may also be contained in the embedded system 120. In this case, operations of the performance evaluator 240 providing or being given the results of performance evaluation to or from the embedded system 120 may be replaced by an internally processed operation.

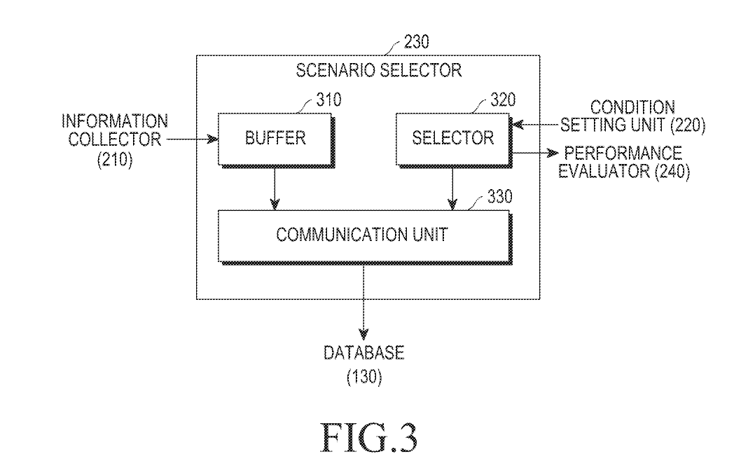

FIG. 3 is a detailed arrangement of the scenario selector 230 shown in FIG. 2. The scenario selector 230 may collect user experiences for the target system and store them in the database 130, and include a buffer 310, a selector 320, and a communication unit 330 to select a user scenario based on the results of collecting the user experience.

Referring to FIG. 3, the buffer 310 may temporarily store the experience information collected periodically or non-periodically by the information collector 210. The buffer 310 may send the temporarily stored experience information to the communication unit 330 at certain intervals or at a separate command.

The communication unit 330 may access the database 130 located at a remote place over a network. Accordingly, the communication unit 330 may send the experience information sent by the buffer 310 to the database 130.

The database 130 may then store and manage the provided experience information. For example, the database 130 may store the experience information comprised of the device (the target system) information, the user's age, location, frequently used program, etc. The reason for locating the database 130 at a remote place is not to set limits on a disc capacity for storing the experience information provided for each user.

The selector 320 may access the database 130 through the communication unit 330 when given information about the condition for scenario selection set by the condition setting unit 220. The selector 320 may then obtain the requisite experience information from the database 130, based on the condition for scenario selection provided by the condition setting unit 220.

For example, the selector 320 may analyze the experience information stored in the database 130 based on the condition for scenario selection, and obtain the requisite experience information according to the analyzed result.

The selector 320 may select a desired scenario for performance evaluation on the target system, using the obtained requisite experience information. The selector 320 may further take into account a hardware configuration of the target system in addition to the requisite experience information in selecting the scenario.

The selector 320 may forward the information about the scenario as selected above to the performance evaluator 240.

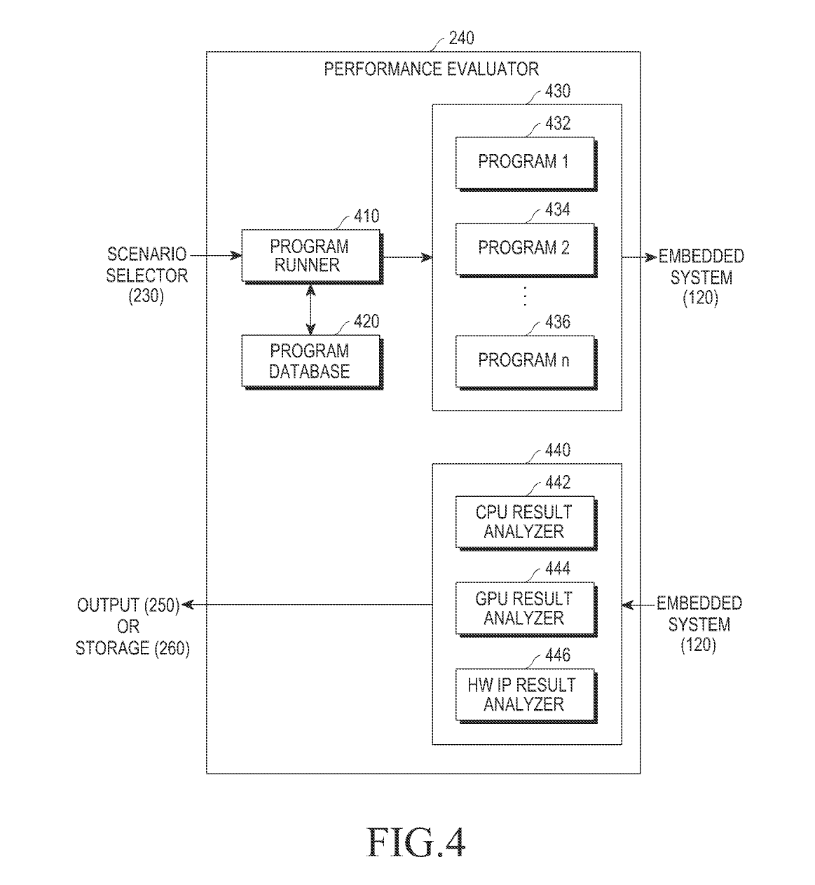

FIG. 4 is a detailed arrangement of the performance evaluator 240 shown in FIG. 2. The performance evaluator 240 may include a program runner 410, a program database 420, an evaluation program 430, and a result analyzer 440, for evaluating a target system, i.e., the embedded system 120, based on a user experience.

Referring to FIG. 4, the program runner 410 may receive the selected scenario from the scenario selector 230. The program runner 410 may configure an evaluation program to be used for the received scenario. For example, the program runner 410 may extract a program to be used for the received scenario among programs managed by the program database 420, and configure the extracted program as the evaluation program.

Reference numeral 430 indicates an example of the evaluation program configured by the program runner 410. The example of the evaluation program 430 is shown to include n programs, program 1 432, program 2 434, . . . , program n 436. The programs included in the evaluation program may be different from each other or some of them are the same.

The evaluation program 430 configured by the program runner 410 or information about the evaluation program 430 may be provided to the embedded system 120 subject to evaluation. Thus, the embedded system 120 may run the evaluation program according to the scenario selected earlier, and perform the performance evaluation and provide results of the performance evaluation to the result analyzer 440 contained in the performance evaluator 240.

The result analyzer 440 may analyze performance of the respective components (e.g., CPU, GPU, HW IP) of the evaluation subject, based on the results of performance evaluation provided from the embedded system 120. The result analyzer 440 may include a CPU result analyzer 442, a GPU result analyzer 444, a HW IP result analyzer 446, etc.

In this case, the results of performance evaluation provided from the embedded system 120 are forwarded to the CPU result analyzer 442, the GPU result analyzer 444, the HW IP result analyzer 446 each. The CPU result analyzer 442 may obtain real-time CPU occupancy information for each evaluation program, by analyzing the forwarded results of performance evaluation, based on the running time of each evaluation program configured earlier. The GPU result analyzer 444 may obtain real-time frame rate information for each evaluation program run by the GPU by analyzing the forwarded results of performance evaluation. The HW IP result analyzer 446 may obtain real-time frame rate information for video or music play IPs by analyzing the forwarded results of performance evaluation.

The analyzed results obtained by each of the CPU result analyzer 442, the GPU result analyzer 444, the HW IP result analyzer 446 may be provided to the output 250 and/or the storage 260.

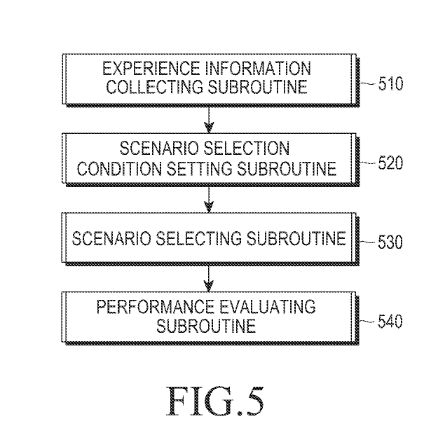

FIG. 5 is a control flowchart for performing performance evaluation on the embedded system by the performance evaluation apparatus 110, according to an embodiment of the present disclosure.

Referring to FIG. 5, the performance evaluation apparatus 110 collects user experience information for a system subject to performance evaluation, in operation 510. Specifically, it performs a subroutine to collect experience information to be taken into account as the user experience in evaluating performance of the target system.

For example, the performance evaluation apparatus 110 periodically or non-periodically collects information about the user's age, gender, location, weather, etc., by exploiting sensor information of the target system, i.e., the embedded system 120 to collect sufficient information of the user experience. The user experience information to be collected periodically or non-periodically needs consent of the user who uses the embedded system 120.

In addition to the aforementioned information, the performance evaluation apparatus 110 may also collect information about a program currently run by the user in the embedded system 120 as the experience information. The information about the program may include information, such as a type of the program the user is running, a running frequency of each program, a running time of each program, etc.

The performance evaluation apparatus 110 stores the collected user experience information in a buffer contained therein. The performance evaluation apparatus 110 forwards the user experience information stored in the buffer to the database 130 located at a remote place over a network, when a predetermined time has elapsed or a predetermined time has come. Thus, the operations in accordance with the experience collection subroutine for collecting user experience information in the target system for performance evaluation and storing the collected user experience information are completed.

The performance evaluation apparatus 110 sets a condition for scenario selection for the target system, i.e., the embedded system 120, in operation 520. Specifically, it performs a subroutine to set a condition for scenario selection to take into account the user experience in evaluating performance of the target system.

For example, the performance evaluation apparatus 110 selects a performance evaluation scenario for evaluating performance of the target system based on the user experience. The performance evaluation apparatus 110 has thus to set a condition for scenario selection to obtain a desired scenario. The condition for scenario selection may be set based on information, such as the user's age, gender, favorite program, etc.

Once the condition for scenario selection is set as discussed above, the performance evaluation apparatus 110 selects a scenario that meets the set condition for scenario selection, in operation 530. Specifically, it performs a subroutine for selecting a scenario to evaluate performance of the target system based on the condition for scenario selection set by taking into account the user experience.

For example, the performance evaluation apparatus 110 analyzes a pattern according to the user experience, i.e., the user experience pattern, based on the set condition for scenario selection. For this, the performance evaluation apparatus 110 searches the database 130 located at a remote place for the user experience information based on the set condition for scenario selection, and analyzes the user experience pattern based on the search results. Upon completion of the analysis on the user experience pattern, the performance evaluation apparatus 110 selects a (best-case or preferred) scenario suitable for performance evaluation based on the analyzed user experience pattern, i.e., the user's age, gender or favorite program.

Once the scenario for performance evaluation is selected, the performance evaluation apparatus 110 evaluates performance of the target system, i.e., the embedded system 120, based on the selected scenario, in operation 540. For this, it performs a performance evaluation subroutine in the embedded system 120, which corresponds to operations under the scenario selected in consideration of the user experience.

For example, the performance evaluation apparatus 110 configures an evaluation program to perform the operations under the selected scenario, and provides the configured evaluation program or information about the evaluation program to the embedded system 120. The embedded system 120 then performs operations under the selected scenario with the evaluation program configured by the performance evaluation apparatus 110. Information regarding the results of performance evaluation obtained by performing the operations under the selected scenario is provided to the performance evaluation apparatus 110.

The performance evaluation apparatus 110 performs the evaluation program based on the results of performance evaluation provided from the embedded system 120. This enables analysis on performance of main components of the embedded system 120. The performance evaluation apparatus 110 outputs the result of analyzing the performance of the main components of the embedded system 120 through a screen or records them in a separate database.

Based on the operations described in connection with FIG. 5, the performance evaluation apparatus 110 may repeatedly perform performance evaluation under different scenarios. Moreover, the user may terminate the program in person.

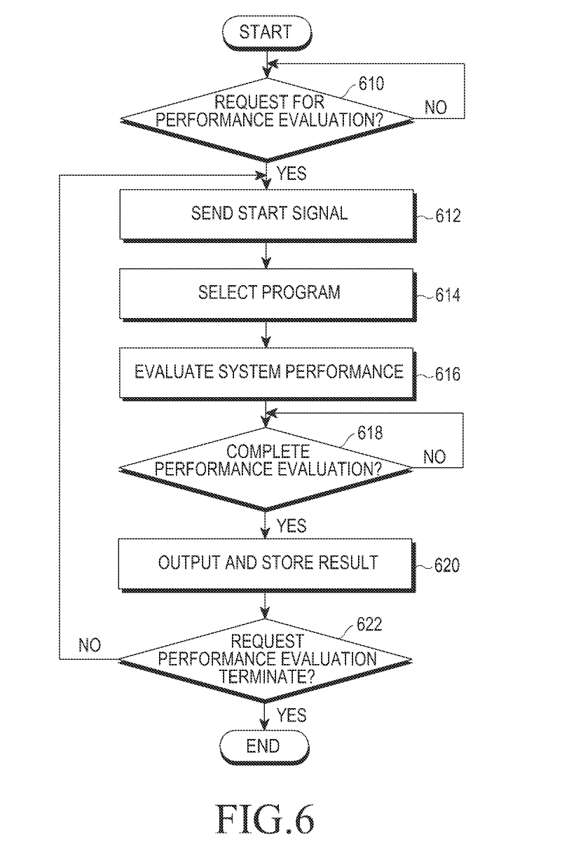

FIG. 6 is a control flowchart corresponding to detailed operations of the performance evaluation subroutine of FIG. 5. Operations of FIG. 6 are performed under the assumption that a scenario for performance evaluation has already been selected by setting characteristic values for a scenario to select a user-experience based scenario and searching a database in which the user experience information is stored, based on the set characteristic values.

Referring to FIG. 6, the performance evaluation apparatus 110 monitors whether there is a request for performance evaluation on the target system from the operator or based on a set condition. The set condition may refer to a predetermined time or a point in time set by the operator for performance evaluation on the target system, or a situation where a particular event, such as usage of a program by the user consistent with the condition for scenario selection, occurs.

In addition, the performance evaluation apparatus 110 may determine whether there is a request for performance evaluation based on whether a circumstance for performing performance evaluation on the target system is given. If the target system or the performance evaluation apparatus 110 is not ready to perform performance evaluation on the target system, it might not be desirable to start performance evaluation on the target system.

Accordingly, the performance evaluation apparatus 110 awaits until there is a request for performance evaluation, i.e., until preparation for performance evaluation is completed.

If the request for performance evaluation on the target system is confirmed by taking into account what are illustrated above, the performance evaluation apparatus 110 sends a start signal for performance evaluation in operation 612. Sending the start signal may be inherently performed in the performance evaluation apparatus 110, and does not need to explicitly appear in the procedure of performance evaluation. It was introduced merely for better understanding of the present disclosure.

The performance evaluation apparatus 110 configures a program to run for performance evaluation on the target system, i.e., an evaluation program, based on the scenario selected, in operation 614.

Once the evaluation program is selected, the performance evaluation apparatus 110 performs performance evaluation on the target system in operation 616. Specifically, it makes the evaluation program run on the target system and analyzes performance of the respective main components of the target system, e.g., CPU, GPU, HW IP, based on the information regarding performance evaluation provided as results of running the evaluation program.

The performance evaluation apparatus 110 permanently or periodically determines whether the ongoing performance evaluation is complete, in operation 618. If the performance evaluation apparatus 110 does not perform performance analysis in real time on the respective main components of the target system, it keeps waiting until the performance evaluation on the target system is completed. In this case, after completion of the performance evaluation on the target system, the performance evaluation apparatus 110 may perform the performance analysis on the respective main components of the target system.

If the performance evaluation apparatus 110 detects completion of the performance evaluation on the target system, it outputs results of the completed performance evaluation on the screen or stores them in a separate database, in operation 620. In other words, the performance evaluation apparatus 110 outputs or stores the results of performance analysis on the respective main components of the target system.

The performance evaluation apparatus 110 determines whether there is a request to terminate the performance evaluation from e.g., the operator, in operation 622. If there is no request to terminate the performance evaluation from the operator, the performance evaluation apparatus 110 may proceed to operation 612 and repeatedly perform the performance evaluation under a scenario selected by a different condition for scenario selection.

The user may terminate the program in person while operations for performance evaluation on the target system are being performed. Furthermore, the performance evaluation may be repeatedly conducted under different scenario configurations.

In accordance with the present disclosure, relatively useful performance evaluation information may be obtained by evaluating performance of an embedded system in consideration of a user experience.

That is, usefulness of a result from performance evaluation conducted on the embedded system may be increased.

Moreover, in accordance with an embodiment of the present disclosure, since performance of the respective main components of a target system may be evaluated, it is possible to conduct complex performance evaluation on the target system.

Other effects obtained or expected from embodiments of the present disclosure are explicitly or implicitly disclosed in the detailed description of the embodiments of the present disclosure. That is, various effects expected from embodiments of the present disclosure will be described in the following description.

It will be appreciated that the embodiments of the present disclosure may be implemented in a form of hardware, software, or a combination of hardware and software. The software may be stored as program instructions or computer readable codes executable on the processor on a computer-readable medium. Examples of the computer readable recording medium include magnetic storage media (e.g., Read Only Memories (ROMs), floppy disks, hard disks, etc.), and optical recording media (e.g., Compact Disk (CD)-ROMs, or Digital Versatile Discs (DVDs)). The computer readable recording medium can also be distributed over network coupled computer systems so that the computer readable code is stored and executed in a distributed fashion. This media can be read by the computer, stored in the memory, and executed by the processor.

The exemplary embodiments may be implemented by a computer or portable terminal including a controller and a memory, and the memory may be an example of the computer readable recording medium suitable for storing a program or programs having instructions that implement the embodiments of the present disclosure. The present invention may be implemented by a program having codes for embodying the apparatus and method described in claims, the program being stored in a machine (or computer) readable storage medium. The program may be electronically carried on any medium, such as communication signals transferred via wired or wireless connection, and the present invention suitably includes its equivalent.

The performance evaluation apparatus and method may receive the program from a program provider wired/wirelessly connected thereto, and store the program. The program provider may include a memory for storing programs having instructions to perform the embodiments of the present disclosure, information necessary for the embodiments of the present disclosure, etc., a communication unit for wired/wirelessly communicating with mobile devices, and a controller for sending the program to the mobile devices on request or automatically.

1. A method for evaluating performance of an embedded system in a performance evaluation apparatus, the method comprising:
obtaining requisite experience information from a database built in advance based on user experience information in using the embedded system, under a predetermined condition for scenario selection;
determining a performance evaluation scenario in consideration of the obtained requisite experience information; and
evaluating performance of the embedded system according to the determined performance evaluation scenario.

2. The method of claim 1, further comprising:
collecting user experience information in driving the embedded system based on a condition arranged or set in advance; and
building the database based on the collected user experience information.

3. The method of claim 1, wherein determining the performance evaluation scenario comprises
analyzing an experience pattern of a user in using the embedded system with the obtained requisite experience information; and
designing a performance evaluation scenario based on the analyzed experience pattern of the user.

4. The method of claim 3, wherein designing the performance evaluation scenario comprises
defining at least one performance evaluation scenario in advance, each corresponding to one of a plurality of experience patterns; and
selecting a performance evaluation scenario for selecting performance of the embedded system from among the at least one performance evaluation scenario, each determined in advance to correspond to one of the plurality of experience patterns, according to the analyzed experience pattern of the user.

5. The method of claim 1, wherein evaluating the performance comprises
running at least one evaluation program in the embedded system according to the determined performance evaluation scenario, and analyzing performance of at least one component subject to evaluation, which is involved in running the at least one evaluation program, among components of the embedded system.

6. The method of claim 5, wherein the component subject to evaluation includes at least one of a central processing unit, a graphic processing unit, and a hardware platform, included in the embedded system.

7. The method of claim 1, wherein the experience information includes identification information and location for the embedded system, and information about a type of a program used, a running frequency of each program, a running time of each program, a user's gender, age, and weather and wherein the condition for scenario selection is information used as a basis for sorting out the experience information and defined by at least one of the identification information of the embedded system, the user's gender, the user's age, and location.

8. A performance evaluation apparatus for evaluating performance of an embedded system, the performance evaluation apparatus comprising:
a scenario selector for obtaining requisite experience information from a database built in advance based on user experience information in using the embedded system, under a predetermined condition for scenario selection, and determining a performance evaluation scenario in consideration of the obtained requisite experience information; and
a performance evaluator for evaluating performance of the embedded system according to the determined performance evaluation scenario.

9. The performance evaluation apparatus of claim 8, wherein the scenario selector is configured to
collect user experience information in driving the embedded system based on a condition arranged or set in advance, and generate a database based on the collected user experience information.

10. The performance evaluation apparatus of claim 8, wherein the scenario selector is configured to
analyze an experience pattern of a user in using the embedded system with the obtained requisite experience information, and design a performance evaluation scenario based on the analyzed experience pattern of the user.

11. The performance evaluation apparatus of claim 10, wherein the scenario selector is configured to
define at least one performance evaluation scenario in advance, each corresponding to one of a plurality of experience patterns; and select a performance evaluation scenario for selecting performance of the embedded system from among the at least one performance evaluation scenario, each determined in advance to correspond to one of the plurality of experience patterns, according to the analyzed experience pattern of the user.

12. The performance evaluation apparatus of claim 8, wherein the performance evaluator is configured to
run at least one evaluation program in the embedded system according to the determined performance evaluation scenario, and analyze performance of at least one component subject to evaluation, which is involved in running the at least one evaluation program, among components of the embedded system.

13. The performance evaluation apparatus of claim 12, wherein the component subject to evaluation includes at least one of a central processing unit, a graphic processing unit, and a hardware platform, included in the embedded system.

14. The performance evaluation apparatus of claim 8, wherein the experience information includes identification information and location for the embedded system, and information about a type of a program used, a running frequency of each program, a running time of each program, a user's gender, age, and weather and wherein the condition for scenario selection is information used as a basis for sorting out the experience information and defined by at least one of the identification information of the embedded system, the user's gender, the user's age, and location.
